(19) United States
(12) Patent Application Publication
(10) Pub. No.: US 2026/0308844 A1
(43) Pub. Date: Oct. 8, 2026

(54) A PROCESS SUITABLE FOR RECYCLING TEXTILE WASTE

(71) Applicant: CURE TECHNOLOGY B.V., Emmen (NL)

(72) Inventors: Marco Brons, Rheden (NL); Johan Albert Frans Kunst, Maastricht (NL); Layo Van Het Goor, Wezep (NL); Ramon Pragt, Emmen (NL)

(21) Appl. No.: 19/481,919

(22) PCT Filed: May 30, 2024
(86) PCT No.: PCT/NL2024/050272

§ 371 Date: Nov. 6, 2025

(30) Foreign Application Priority Data
Jun. 1, 2023 (NL) 2034965

(51) Int. Cl. D06P 5/13; C08J 11/10; D02G 3/02

(52) U.S. Cl. CPC D06P 5/137; C08J 11/10; D02G 3/02; C08J 2367/00; D10B 2201/02; D10B 2331/04; D10B 2331/10

(57) ABSTRACT

A process suitable for recycling textile waste including polyester yarns containing a dye, the process including a first step wherein the polyester yarns are treated with a solvent to extract a part of the dye from the polyester yarns, a second step wherein the solvent treated polyester yarns are subjected to a method wherein the polyester is depolymerised into an oligomeric ester consisting of in average between 3 and 30 monomeric units, wherein the remaining part of the dye is removed from the oligomeric ester by adsorption to a particulate matter that is in a mixture with the oligomeric ester, and a third step wherein the oligomeric ester is separated from the particulate matter including the adsorbed dye, therewith providing a decolourised oligomeric ester suitable for repolymerisation, consisting of in average between 3 and 30 monomeric units.

### GENERAL FIELD OF THE INVENTION

The invention pertains to the field of recycling dyed textile waste material, in particular material comprising semi-crystalline polyester such as for example polyethylene terephthalate (PET).

### BACKGROUND OF THE INVENTION

Polyester, such as PET as commonly used for soda bottles and yarn materials for producing textiles, is commonly recycled. The post-consumer polyester recycling industry started as a result of environmental pressure to improve waste management. The other aspect that acts as driving force for polyester recycling industry is that polyester products have a slow rate of natural decomposition. Many polyesters are non-degradable plastics in normal conditions since there is no known organism that can consume its relatively large molecules. Complicated and expensive procedures need to be operated in order for polyester to degrade biologically.

The first recycling effort of polyester waste material (i.e. post-consumer polyester objects or material) in the world was in the 1970's but the development of adequate recycling processes evolved quickly. As an example, the total consumption of PET in Australia for the year 2000 was 88,258 tons, in which 28,113 tons were recovered demonstrating a recovery rate of about 32%. Many researchers reported that in order to achieve successful PET recycling, PET flakes should meet certain minimum requirements. The major factor affecting the suitability of post-consumer PET flakes for recycling is the level and nature of contaminants present in the flakes. Minimizing the amount of these contaminants leads to better rPET (i.e. recycled PET) quality. PET is contaminated with many substances such as acid producing contaminants, water, colouring contaminants, acetaldehyde and other contaminants such as detergents, fuel, pesticides, etc. due to the use of PET bottles for storing these substances.

Various distinct types of processes have been applied in order to recycle polyester waste materials, each having their pros and cons.

Much applied is the so-called energetic recycling such as pyrolysis and carbonization. Pyrolysis of polyester waste was first described in the early 1980's. It is an alternative to PET disposal in landfills. In general, polyester waste is pyrolysed without further purification of the plastic waste. The majority of pyrolyses are conducted to produce aliphatic and aromatic hydrocarbons as an alternative for fossil fuels or as a source for chemicals. Carbonization is a second method of pyrolyzing polyester waste materials. Next to this, the mere sorting of the polyester waste material, followed by use of the sorted materials as additive in stone mastic asphalt, cementitious materials, mortars or concrete composites.

In recent years chemical recycling of polyester has been developed and applied in practice. In chemical recycling (chemolysis) processes, recycling of polyester waste material is enabled by depolymerisation into monomers and/or oligomers. This class can be divided in numerous sub-classes depending on the type of reactant used for the chemolysis. Examples are the application of ionic liquids for de-polymerization, or using castor oil for de-polymerisation. Also, polyester polymers can be degraded by enzymes as first described in the 1970's. As the use of ionic liquids and castor oil, this bio-chemical method was developed to provide an eco-friendly procedure of polymer recycling in contrast to conventional chemical recycling methods. However, efficiency is rather low with respect to complete de-polymerization of the polyester and hence quantitative recovery of homogeneous reaction products for re-use is not possible.

Alcoholysis for de-polymerization of PET was first described in the early 1990's. This method was developed to avoid the drawbacks of the acidic and alkaline hydrolysis (pollution problems) to provide a renewable and more eco-friendly degrading agent for polymers. Generally, polyester is de-polymerised with an excess of an alcohol to yield corresponding esters of the corresponding acid and ethylene glycol. Among the alcoholysis methods, reaction with methanol has gained special importance because of the low price and the availability of methanol. Also ethylene glycol (a diol, the use of which is sometimes classed separately as “glycolysis”, although it falls in the class of alcoholysis) is used mainly in reactive extrusion to produce low molecular weight oligomers.

Aminolysis and ammonolysis were developed for polyester recycling, since the reactivity of the amine-group is higher than the hydroxyl-group or alcohols used alcoholysis of polyester. However, as far alcoholysis, the need for a metal catalyst remains.

Lastly, an alternative chemical recycling of polyester is given by the controlled de-polymerization of polyester using blocking chain scission with defined amounts of the de-polymerization agent. This method produces polyester oligomers of well-defined molecular weights in a greater range than existing chemical methods like alcoholysis. However, this method requires sorted polyester material, which has to be free of contaminants.

All chemical recycling processes require the removal of any dyes from the polymer to ensure high-end re-use of the recycled material. In the art many methods to arrive at (almost full) removal of dyes from polymer materials, in particular polyester yarns form textile materials are described.

US 2015/0059103 (assigned to Far Eastern New Century Corp, Taiwan) discloses a method for decolourisation of a dyed polyester yarn, including separately providing a dyed polyester yarn stained with a dye, and a solvent capable of completely dissolving the dye. In the method the solvent is heated to produce a fresh vapor of the solvent, the temperature being relatively high, ranging between the glass transition temperature and the melting point of the polyester. Then, the fresh vapor is condensed to form a condensed fluid of the solvent and thereafter the dyed polyester yarn is contacted with the condensed fluid of the solvent to dissolve the dye such that the dye is extracted from the yarn so as to form a dye-containing solution and a decolourised polyester yarn, which can be easily separated. It is difficult to find a solvent that is capable of completely decolourising the yarn without chemical break down of the polyester.

US 2022/0169786 (assigned to Sintech Corp and Jeplan Inc, both of Japan) discloses a method for producing a decolourised polyester using a decolourising agent containing a glycol ether type compound having a boiling point at atmospheric pressure of 160° C. or higher, the method including a step of removing the dyes, by bringing the said decolourising agent into contact at least once with the coloured polyester while heating the decolourising agent to a temperature equal to or lower than a melting point of the polyester, to thereby obtain the decolourised polyester. Depending on the type of decolourising agent, the method can be effective but at the costs of a very high energy consumption and with a severe risk of chemical breakdown of the polyester.

US 2020/0270790 (assigned to Nan Ya Plastics Corp, Taiwan) discloses a method for decolourisation of a dyed polyester yarn. The method includes the step of providing an ether-alcohol solvent, heating the ether-alcohol solvent up to a boiling point of the ether-alcohol solvent to continuingly generate a fresh gas having a temperature from 90° C. to 200° C. This way, the dye can be extracted from the polyester yarn forming an extracting condensate containing the dye, which can be reflowed back into the ether-alcohol solvent. This has to be repeated a number of times in order to extract all dye from the polyester yarn. This is a time and energy consuming process.

Nan Ya Corporation has another recent patent application assigned to her, viz. US 2023/0093536, wherein in addition to the dye, a water repellent compound is also extracted from the polyester yarn. In this method a composite solvent containing water and acetic acid mixed with each other is used for the extraction operation which includes infiltrating the polyester yarns (may be in the form of complete fabric) with the composite solvent and extracting the dye and the water repellent, and carrying out a liquid state polycondensation reaction on the polyester fabric so that an intrinsic viscosity of the polyester fabric is increased and residual impurities of the polyester fabric are further removed.

Nan Ya Corporation has a further recent patent application assigned to her, viz. US 2003/0080748. In this patent application it is described to remove any colourant attached to the surface of the polymer material can be pre-extracted, whereafter the polymer is broken down into its monomeric units, i.e. BHET in the case of polyester. The breakdown to BHET is essential to this process and ensures that any colourant is released into the fluid material and can be removed by using any adsorbent material such as active carbon. In particular for dark yarns wherein high amounts of colourants are present, the use of large amounts of active carbon is needed.

U.S. Pat. No. 7,192,988 (assigned to Invista) describes a method of depolymerising PET and the henceforth removal of any released colourants by a combination of absorption to particulate matter like active carbon and solvent extraction. This way then amount of carbon can be kept to a minimum to ensure economically viable purification of the monomers.

JP 200533044 (assigned to IS KK), discloses a method for recovering an ester monomer from polyester yarns comprising the steps of carrying out extraction by contacting the polyester yarns with an ethylene glycol extractant until a low degree of colouring is arrived at and thereafter carrying out depolymerisation processing to the ester monomers, and carrying out monomer purification.

WO 2022/003084 (assigned to Cure Technology BV) describes a method wherein before any dyes are removed, the polymer is broken down to a low viscous oligomer, from which the dyes can be removed using active carbon or another dye-adsorbing particulate material that can be easily mixed through the material and filtered therefrom. However, apart from the fact that the process of separating the carbon from the oligomer melt is time and energy consuming, the recycling of the large amounts of active carbon needed for complete dye removal is a severe disadvantage of this method. Also, the combination of a more viscous oligomeric material and the active carbon means that there are limits on the amount of colourant that can be removed this way.

A need exists for improved methods for decolourising polymer yarns to enable easy recycling of textile waste. In particular, a need exists to decolourise polymer yarns of which the bulk of the polymer material is coloured with a dye, and wherein purification of any resulting depolymerisation product is relatively easy.

### SUMMARY OF THE INVENTION

In order to meet the object of the invention, a process for decolourising dyed polyester yarns has been devised, enabling the recycling of textile waste that comprises these polyester yarns, the process comprising a first step wherein the polyester yarns are treated with a solvent to extract a part of the dye from the polyester yarns, followed by a second step wherein the solvent treated polyester yarns are subjected to a method wherein the polyester is depolymerised into an oligomeric ester consisting of in average between 3 and 30 monomeric units, wherein the remaining part of the dye is removed from the oligomeric ester by adsorption to a particulate matter that is in a mixture with the oligomeric ester, and yet another step wherein the oligomeric ester is separated from the particulate matter comprising the adsorbed dye. This way a decolourised oligomeric ester suitable for repolymerisation, consisting of in average between 3 and 30 monomeric units, is provided. Such decolourised oligomer has found to be ideally suitable for repolymerisation into a high-end quality polyester. Surprisingly, the amount of colourant that can be removed by solvent extraction, even if in the bulk of the polymer, is so high that there appears to be no need to depolymerise the remaining material to its monomeric units and still be able to remove the last colourants up to a very high level with a particulate absorbent material such as active carbon.

It is noted that the particulate matter can be actively mixed into the oligomeric ester (or mixed with the polyester, preceding its depolymerisation, leading to the required mixture upon the depolymerisation), or passively mixed, e.g. by pumping the oligomeric ester (which is a liquid due to its low level (degree) of polymerisation) through a bed of this particulate material, or in any other means which enables forming a mixture of the particulate matter and the oligomeric ester.

It is also noted that the separation step wherein the oligomeric ester is separated from the particulate matter is not restricted to a step wherein the oligomeric ester is actively separated from the particulate matter. For example, if in the method the oligomeric ester is pumped through a solid bed of the particulate material, at the end of the bed the separation between the two constituents inherently takes place.

The invention is based i.a. on the recognition that by combining the two processes, i.e. partly removing the dyes(s) with a solvent, and removing the remainder with a particulate adsorbent after the polyester has been broken down into an oligomeric ester, provides far more freedom to operate, while at the same time allowing a very high purification of the polymer material without the need to depolymerise this material to its monomeric units: the choice of solvent is far less critical since it is not necessary to remove the complete amount of dye with the extraction step. Also, circumstances may be chosen that favour breakdown of the polymer (typically unwanted when aiming at recycling of the polymer) since the polymer will be broken down anyway into a oligomer for repolymerisation. Also, the removal of the remainder of the dye out of the oligomeric ester with a particulate adsorbent is less critical since the amount to be removed may be far less than the total amount of dye present in the original polyester yarns. So for example a less efficient adsorbent may be chosen as a trade off against easy (economically favourable) separation or re-activation etc, or the other way around if more favourable in the overall process.

It is essential that the oligomeric ester consists in average of at most 30 monomeric units, since otherwise the viscosity will be too high for easy mixing and/or separation of the particulate matter with the oligomer. Still, a number of monomeric units below 3 is also less favourable due to the need of repolymerisation into a polyester. Repolymerisation costs too much time if the number of units in the oligomer is below 3. Time not only costs money but also poses a risk of unwanted degradation of the polyester.

In the first step of the invention, solvents that are able to solve dyestuffs are used, such as for example alcohols, ethers, ketones, aliphatic and aromatic hydrocarbons, oils, fats, waxes, and chlorinated hydrocarbons. It was found that it is possible not only to remove colourants which are attached to the surface of the yarns can be removed, but even colourants present in the bulk of the polymer material.

For the second step in the method of the invention, typically highly porous adsorbents with good selectivity are used. Activated carbon has shown excellent ability to remove organic compounds such as dyes. The adsorption of dye onto adsorbents can be a physical or a chemical process. In the physical adsorption mechanism, the dye molecules attach onto the adsorbent surface under the influence of van der Waals forces and hydrogen bonding. During chemisorption, the dye molecule or ion attaches itself to a specific surface functional group or site by a chemical bond. Many different dye functional groups can participate in multiple adsorptive attachments over a wide range of available adsorbents.

### Definitions

A polyester is a polymer in which the monomer units are linked together by an ester group. They are typically formed by polymerizing a polyhydric alcohol with a polybasic acid, and used mainly in the manufacture of resins, plastics, and textile fibres. It is well known that polyesters may be prepared by a condensation polymerisation process in which monomers providing the “acid component” (including ester-forming derivatives thereof) are reacted with monomers providing a “hydroxyl component”. If desired the polyesters may also comprise other linking groups such as for example a proportion of carbonylamino linking groups —C(═O)—NH— (i.e. amide linking group) or —C(═O)—N—R²-(tertiary amide linking group). Polyester as used in ever-day live can be aliphatic, semi-aromatic or aromatic. Typical examples are polyglycolic acid (PGA), polylactic acid (PLA), polycaprolactone (PCL), polyhydroxyalkanoate (PHA), polyhydroxybutyrate (PHB), polyethylene adipate (PEA), polybutylene succinate (PBS), poly(3-hydroxybutyrate-co-3-hydroxyvalerate) (PHBV), polyethylene terephthalate (PET), polybutylene terephthalate (PBT), polytrimethylene terephthalate (PTT), polyethylene naphthalate (PEN) and Vectran®, a polycondensation product of 4-hydroxybenzoic acid and 6-hydroxynaphthalene-2-carboxylic acid. Of these PET, also abbreviated as PETE, or the obsolete PETP or PET-P, is the most common thermoplastic polymer resin of the polyester family and the virgin material is considered as one of the most important engineering polymers of the past decades. It is regarded an excellent material for many applications and is used in fibres for clothing, containers for liquids and foods, thermoforming for manufacturing, and in combination with glass fibre for engineering resins. It is also referred to by brand names such as Terylene, Amite, Eastapac, Mylar, Lavsan, Dacron etc. A polyester item (such as a polyester yarn) may contain up to 50% (w/w) of non-polyester polymer chains (e.g. 0, 1, 2, 3, 4, 5, 6, 7, 8, 9, 10, 15, 20, 25, 30, 35, 40, 45, 50%) while still being referred to as a polyester item.

A dye is a coloured substance that chemically bonds to a substrate to which it is being applied. Typically, dyes impart colour to a substrate when applied in solution from either aqueous or organic solvents.

A pigment is a coloured substance that is completely or nearly insoluble. In contrast, dyes are typically soluble, at least at some stage in their use.

Post-consumer textile waste is a post-consumer fabric material at or after the end of its consumer life-time, i.e. the time during which it is used by a consumer for practical or esthetical purposes.

Depolymerising means to lower molecular weight, by breaking down the original polyester molecules to shorter length molecules down to for example oligomers.

Polyurethane refers to a class of polymers composed of organic units joined by carbamate (urethane) links. A polyurethane item (such as a polyurethane fibre or drop of polyurethane adhesive) may contain up to 50% (w/w) of non-polyurethane polymer chains (e.g. 0, 1, 2, 3, 4, 5, 6, 7, 8, 9, 10, 15, 20, 25, 30, 35, 40, 45, 50%) while still being referred to as a polyurethane item.

DGME is 2-(2-ethoxyethoxy)ethanol, a colourless liquid. It is produced by the ethoxylation of ethanol.

Elastane is a polymer known as polyurethane, a polyether-polyurea copolymer. Elastane fabric is the generic term used to describe branded textiles such as Lycra®. This type of fabric is also called Spandex®, and its primary attribute is its incredible elasticity. While Lycra®, Spandex®, and elastane are all the same material, regional variants of the term “elastane” are most commonly used to refer to this type of fabric.

A part of an amount of item means less than the whole amount or complete item.

An oligomer is a chain of chemically bonded monomers having up to 50 subunits. The term oligomer often denotes a mixture of molecules with a different length (a different amount if subunits), typically denoted with its mean number of subunits.

Particulate matter means matter that comprises solid particles, i.e. small localised objects which can be described by several physical or chemical properties, such as volume, density, or mass. Typically, particles are macroscopic particles like powders and other granular materials.

Adsorption to a particulate matter means to be bound to the surface of the matter, which does not exclude that the surface is an internal surface of for example a pore.

Mixing two materials means to combine or blend these two materials into one macroscopic mass. The mass is preferably homogenous on a macroscopic (i.e. on a 5 mm scale, preferably on a 4, 3, 2, 1, or even below 1 mm scale).

To shred is to divide into smaller pieces, for example by cutting.

### FURTHER EMBODIMENTS OF THE INVENTION

In a first further embodiment of the process according to the invention at least 50% of the dye (w/w) is extracted from the polyester yarns in the first step, preferably at least 55, 60, 61, 62, 63, 64, 65, 66, 67, 68, 69, 70, 71, 72, 73, 74, 75, 76, 77, 78, 79, 80, 81, 82, 83, 84, 85, 86, 87, 88, 90, 91, 92, 93, 94, 95, 96, 97, 98, up to 99%. The more dye is extracted in the first step, the less particulate adsorbent need to be recycled from the second step.

In a second further embodiment of the process according to the invention, the particulate matter is chosen from activated carbon, zeolites, silica gel, activated alumina, inorganic minerals, chitosan, resin particles, carbon nanotubes and aluminophosphate molecular sieves, whereas activated carbon (also denoted as AC) is the preferred particulate matter.

In again another embodiment of the process according to the invention, the process comprises the step of filtering the oligomeric ester using a filter having a mesh size below 20 μm, preferably between 5 and 10 μm. Due to its low viscosity, the oligmeric ester can be filtered at a low cost of energy to remove any pigments and any other small particulate matter if present.

In yet again another embodiment of the process according to the invention, the polyester is depolymerised into an oligomeric ester consisting of in average between 5 and 20 monomeric units. A lower limit of 5 monomeric units is advantageous given the fact that the oligomer will eventually be repolymerised in a polyester polymer of high molecular weight. This takes less time and energy when the starting material has a somewhat higher degree of polymerisation. The upper limit of 20 monomeric units is advantageous for the step of separating the particulate matter from the oligomeric ester, and the optional use of small mesh filters. Above 20 monomeric units the viscosity increase means an increase in costs for these processes.

In still another embodiment of the process according to the invention, the solvent used to extract the dye from the polyester yarns is an ester or an ether. These types of solvents have found to be ideally suitable for use in the present process. Given the fact that the extraction is incomplete per se in the first step, the actual solvent used is less critical. Still, advantageously the solvent has a boiling temperature between 140° C. and 250° C., preferably between 150° C. and 220° C. Since many different, in particular non-polyester materials that are used for making polyester textiles have a melting point in this range, the solvent can thus be used for selective removal of these particular materials if desired. In particular for post-consumer polyester waste streams, this has shown to be a particular advantage, given the fact that polyester waste streams almost without exception also comprises other polymer materials. Good examples of effective solvents for use in the present invention are solvents chosen from the alkyl lactates or glycol ethers, preferably being either ethyl lactate or diethylene glycol monoethyl ether (DGME).

The inventors also recognised that a particular “contamination” of polyester textile is with polyurethane (PUR) items, such as PUR yarns (e.g. so called elastane), adhesive or foam, and found that it is advantageous that before the step of depolymerisation of the polyester, the PUR items are removed from the polyester yarns by either mechanical and/or chemical methods (which methods as such are commonly known in the art). This is to prevent that the PUR items, or a product derived therefrom, interfere in the process of depolymerisation and potentially end up in the oligomeric ester. Preferably the PUR items are removed by using a PUR solvent. This has found to be an easy way of removing the PUR items before the depolymerisation step commences. Even further it was found that it is very advantageous that the PUR solvent is the same solvent that extracts a part of the dye from the polyester yarns in the first process step.

Various solvents can be used for this, but the most preferred one is DGME. It is noted that WO2023044699 (assigned to Hong Kong Research Institute of Textiles & Apparel Ltd) describes a method of separating Spandex® (which is a polyurethane yarn) from textile blends using biosolvents like ethyl lactate. The present inventors found that ethyl lactate is highly inefficient in extracting Spandex® from textile waste but that DGME on the contrary, not mentioned in WO2023044699 since not being a biosolvent, is highly efficient. Even more surprisingly, it was found that after extraction of the dye and polyurethane using DGME, the PUR polymer can be obtained in purified form by pouring the DGME with the extracted PUR and dye into water, which was found to lead to a solid highly pure PUR fraction in the aqueous fraction.

In yet a further embodiment of the process according to the invention, wherein the textile waste in addition to the polyester yarns comprises cotton items such as cotton yarns and the like, the process is further improved in that before the step of depolymerisation of the polyester, the cotton items are removed from the polyester yarns by either mechanical and/or chemical methods (which methods as such are commonly known in the art). This is to prevent that the cotton items, or a product derived therefrom, interfere in the process of depolymerisation and potentially end up in the oligomeric ester. Typically, the cotton is decolourised before it is removed from the textile waste. The process of removing the cotton item may take place before or after (or at the same time of) removal of the dye from the polyester yarn.

In a preferred embodiment of the method according to the invention, the polyester is depolymerised into an oligomeric ester by alcoholysis. Such a process is known i.a. from WO2022/003084 (assigned to Cure Technology BV) and was found to be particularly suitable for use in the present invention. In particular, it was found to be advantageous that the polyester is depolymerised into an oligomeric ester by a two-step procedure, comprising two separate consecutive steps, in both of which alcohol is added to depolymerise the polyester. Further in particular, it was found advantageous that in the first of the two consecutive steps the polyester is fed to an extruder operated at a temperature above the melting temperature of the polyester, while a first amount of alcohol is co-fed to the extruder, in order to produce a fluid mixture comprising a melt of at least partly depolymerised polyester, and in the second of the two consecutive step the said fluid mixture is fed to a continuously stirred tank reactor (CSTR) operated at a temperature above the melting temperature of the polyester, while co-feeding a second amount of alcohol to the CSTR to provide the oligomeric ester.

In yet again another embodiment of the process according to the invention the polyester is polyethylene terephthalate (PET) and the oligomeric ester comprises for over 50% w/w, preferably over 60, 65, 70, 75, 80, 81, 82, 83, 84, 85, 86, 87, 88, 89 or even 90, 91, 92, 93, 94, 95, 96, 97, 98, 99 or even 100% w/w, oligomers of 4 to 16 Bis(2-Hydroxyethyl) terephthalate (BHET) units, preferably 6 to 14 (BHET) units, most preferably, 8 to 10 BHET units.

In still a further embodiment of the process according to the invention, after extraction of the dye with the solvent, the dye is removed from the solvent in a separate step to provide purified dye and purified solvent. Such steps as such are known in the art and might for example be a simple concentration step, or a process comprising membrane diffusion, a distillation process etc, all aiming at complete recycling of the dye as well as the solvent. Correspondingly, after the oligomeric ester is separated from the particulate matter comprising the adsorbed dye, the dye is removed from the particulate matter to provide purified dye and purified particulate matter.

Lastly, the invention is embodied in a process that is preceded by one or more of the steps chosen from the group consisting of 1) removing any trims such as buttons, zippers and labels from the textile waste, 2) washing the textile waste (e.g. to remove any coating such as a DWR (Durable Water Repellent), or spinner oils, dirt, suint etc.) and 3) shredding the textile waste into smaller pieces. The order of performing these steps, which as such are commonly known in the art, is not essential for this embodiment.

The invention will now be further explained using the following specific examples.

### EXAMPLES

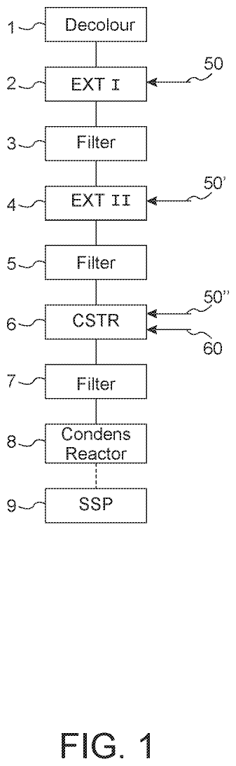

FIG. 1 schematically depicts an overview of a process according to the invention.

Example 1 provides various experiments, including a two stage depolymerisation process for polyester.

Example 2 shows an initial decolouring step of a blue fabric with ethyl lactate.

Example 3 shows an initial decolouring step of the same blue fabric with DGME.

Example 4 is an example of initially decolouring a green fabric with ethyl lactate, wherein the fabric is coated with DWR, the fabric containing small amounts of elastane (PUR) yarns, mechanically connected to the polyester yarns.

Example 5 shows the result of decolouring the same green fabric with ethyl lactate at lower temperatures.

Example 6 is another example of decolouring the same green fabric with DGME.

Example 7 was performed to assess the use of the present method with a textile waste comprising a relatively high amount of elastane.

Example 8 shows the dissolution of compressed elastane fibers.

Example 9 is a further example of dissolution of compressed elastane fibers.

Example 10 shows the dissolution of polyurethane foam as an item in textile waste.

Example 11 shows the decolouring blue fabric with xylene

Example 12 briefly describes a few comparative examples.

### FIG. 1

FIG. 1 schematically depicts an overview of a process according to the invention. In the shown process, washed and pre-dried mixed polymer waste material, in this case textile waste comprising elastane and dyed PET yarns, is treated in a first step with DGME to extract a substantial part of the dye from the polyester yarns and dissolve all elastane yarns. Thereafter, the PET is separated from the liquid DGME fraction and depolymerised and repolymerised in a continuous process through steps 2-8, while at the same time any remaining dye (as well as pigments) are removed from the PET. Step 9 is an additional repolymerisation step including solid-state polymerisation, to arrive at a an intrinsic viscosity (IV) above 0.6.

The depolymerisation process is based on the commonly known equilibrium reaction of PET in an alcoholysis based on mono ethylene glycol (MEG):

$$BHET ↔ [ PET ] x + \frac{1}{2} \times MEG$$

By adding MEG to the polyester melt, the equilibrium shift to the left, resulting in shorter polymer chains, ultimately oligomers (less than 100 repeating BHET units, in particular less than 50, 40, 30, 20 or even 10 units) and decreasing viscosity. By removing MEG, for example by using a vacuum or nitrogen, the short chains react with each other to form a polyester again. By controlling the depolymerisation rate, and thus the oligomer length, the viscosity of the material is controlled.

In step 1, the textile waste material is treated with DGME, by dispersing the material in the DGME and applying continuous mixing. This way a substantial part of the dye is extracted from the polyester yarns, while at the same time completely dissolving the elastane yarns. We refer to the further examples here below showing that DGME is ideally suitable in this step, when compared to other solvents. Then, in step 2 the partly decoloured polyester fraction is fed to a conical co-rotating twin screw extruder. The extruder is operated at 280° C. to melt the polyester completely. Adjacent the end of the conical twin screw extruder (at 10% of its length) an injection point for dosing MEG (indicated as arrow 50) is provided to obtain the first step in depolymerization, thus reducing the viscosity. For this, about 1% of MEG (w/w) is dosed. The reduction of the IV also helps to minimize the pressure difference over the first filtration step 3 to make it possible to filtrate with a mesh size of 80 micrometre. The filter also acts as a static mixer to homogenize the mixture and distribute the added glycol with the molten polymer to react completely with shorter polymer chains and a molecular weight distribution at equilibrium (dispersion grade of about 2) as a result. Process parameters are chosen such that the MEG is (almost) fully reacted and no (hardly any) free MEG is present anymore.

The partly depolymerized and filtered material is fed to a single screw extruder in step 4. Typically, about 3-4% of MEG is dosed in this extruder (indicated by arrow 50′). At the end of the extruder the viscosity of the melt is measured. The level of the viscosity is controlled by an automated control loop (not indicated in FIG. 1) controlling the level of MEG being dosed in the single screw extruder. This automated control loop results in a consistent viscosity, typically an IV between 0.1 and 0.2, independent of the IV of the starting material. Due to the inherent transesterification reaction which takes place in the extruder, the polydispersity may remain low, preferably around 2-3, depending mainly on the residence time in the extruder (which may be adjusted in the process by controlling initial feed and extruder speed).

The depolymerized material is filtered for a second time in step 5. Due to the IV of about 0.15 the filtration size can be reduced in comparison to the first filter, preferable being 40 micrometre, without a pressure difference over the filter being too high.

The material with an IV of about 0.15 (0.1-0.2) is continuously added to a continuous stirred tank reactor (CSTR) in step 6. In this CSTR also MEG is added (indicated by arrow 50″) to further depolymerize the material to the required viscosity/oligomer length.

In the CSTR, further decolouration takes place by adding activated carbon, indicated by arrow 60. The activated carbon may be pre-selected for the best performance to absorb any of the remaining colourants (i.e. the dyes) present in the polyester waste. After the CSTR, the low viscous oligomer/activated carbon mixture is pumped through a three-step micro filtration (20/10/5 micrometre) step 7 to remove the carbon particles loaded with colourant from the oligomers. A parallel set of three filters is installed so that in case of a pressure difference over the filter that is too high, the melt can be pumped through the parallel set, while the first filter set can be cleaned.

After the filtration while the melt is still at an elevated temperature of about 250° C., the melt is pumped to the polycondensation reactor (step 8) which is operated under vacuum at 1 mbar, at a temperature of about 260° C., to remove the MEG, with the result that the equilibrium of the BHET/PET equilibrium shifts to the right forming the PET polymer. Due to the processing conditions, a polyester with an IV between 0.4 and 0.6 can be obtained. The polymer is removed from the reactor and pumped through a die-plate provide with holes, thus generating polymer strands. These strands are cooled down and cut into amorphous granules to produce new polyester products.

### Example 1

Example 1 describes a two stage depolymerisation process and integrated decolouration of the resulting oligomeric ester according to the invention. In particular, this example provides results achieved with alcoholysis, in particular glycolysis, using MEG as a reactant for depolymerising PET in a single screw extruder and in combination with a CSTR configured as a continuous process. This process is described in detail in international patent application WO 2022/003084 (Example 2). Although used in that patent application for recycling carpet and bottle waste, it is equally applicable to textile waste comprising polyester yarns.

Reactive extrusion tests were performed using up to 3% w/w MEG with dried PET yarns. The glycolysis process took place very rapidly. The PET was depolymerised into oligomers within 30 seconds. The dosed MEG had almost completely reacted in this time frame. Over 98% of the dosed MEG had been used for the glycolysis process.

The HPLC analysis confirm that a significant amount of BHET to tetramer when applying 12% MEG or more (see table 1). However, in order to be able and filter the melt, it is not necessary to depolymerize this far. A viscosity of (IV=±) 0.1 is sufficient for the filtration process. This corresponds to a 8-10 (octa-deca) oligomer. This will require 5% to 8% MEG w/w.

TABLE 1
Analysis of the oligomers (relative to pure BHET)

| Sample | BHET | dimer | trimer | tetramer | pentamer | hexamer | heptamer | octamer |
|---|---|---|---|---|---|---|---|---|
| 6 | 12.6 | 17.1 | 14.3 | 12.0 | 6.1 | 1.8 | 0.6 | 0.4 |
| 7 | 10.3 | 14.9 | 13.8 | 10.2 | 5.1 | 1.4 | 0.4 | 0.3 |

At such a relatively low viscosity (of around 0.1 IV) it is very easy to remove any remaining colourant using active carbon, or any other particulate material, to adsorb the remaining dye. The active carbon itself, together with any pigments (if present) can be removed by using filters as described here above with regard to FIG. 1.

### Example 2

Example 2 shows an initial decolouring step of a blue pure polyester fabric with the solvent ethyl lactate. First, in total 75 g of a blue coloured fabric which is typically used as sofa covering and made of PET fibers, was cut into small pieces and subsequently charged to a 500 mL glass reactor, equipped with condenser, thermometer, and nitrogen inlet. Then, 450 g of ethyl lactate was added and the contents of the glass reactor was gently heated to reflux (150-155° C.) with a heating mantle under continuous magnetic agitation. After reaching reflux conditions, the contents of the glass reactor was kept at these conditions for 60 min. During this period, visible removal of colourants was affected by the aid of the ethyl lactate solvent, which coloured dark green to blue and appeared transparent. Then the less coloured fabric pieces were separated from the dark green to blue solvent containing the removed colourants by standard solid-liquid filtration.

Then the fabric pieces of the first colourant removal step were charged to the same glass reactor as used for the colour removal step, followed by 450 g of fresh ethyl lactate. The contents of the glass reactor was gently heated to reflux (150-155° C.) with a heating mantle under continuous magnetic agitation. After reaching reflux conditions, the contents of the glass reactor was kept at these conditions for 60 min. During this period, visible removal of colourants was affected by the aid of the ethyl lactate solvent, thereby rendering the fabric pieces only slightly green and the solvent dark green to blue. The slightly green fabric pieces were separated from the dark green to blue solvent containing the removed colourants by standard solid-liquid filtration.

It is estimated that about 60-80% w/w of the amount of dye is removed from the fabric by the extraction process.

### Example 3

Example 3 shows an initial decolouring step of the same polyester blue fabric as used in Example 2, but now with the solvent diethylene glycol monoethyl ether (DGME). First, in total 20 g of the fabric was cut into small pieces and subsequently charged to a 500 mL glass reactor, equipped with condenser, thermometer, and nitrogen inlet. Then, 125 g of diethylene glycol monoethyl ether (DGME) was added and the contents of the glass reactor was gently heated to reflux (200-205° C.) under continuous magnetic agitation. Already during heating the fabric pieces showed almost complete colour removal and the solvent coloured orange to red and appeared transparent. After reaching reflux conditions, the contents of the glass reactor was kept at these conditions for 15 min. Then the decoloured fabric pieces (slightly yellow) were separated from the orange to red solvent containing the removed colourants by standard solid-liquid filtration.

It is estimated that about 90-95% w/w of the amount of dye is removed from the fabric by the extraction process. This partly decoloured material can be used as input for the depolymerisation process wherein the remainder of the dye is removed with active carbon.

### Example 4

Example 4 is an example of initially decolouring a green fabric with ethyl lactate, wherein the fabric is coated with a so called durable water-repellent (DWR) coating on its surface. This is to assess whether dye can also be extracted from the polyester when such a common coating is present. First, in total 1 g of a green fabric with a durable water-repellent (DWR) coating on its surface, that is used in outdoor applications and is made of mainly PET fibers and 2% elastane fibers, was cut into small pieces. Then, 60 g of ethyl lactate was charged to a 150 mL glass beaker, which was equipped with thermometer, and the contents of the glass beaker was gently heated to 150° C. (just below boiling temperature) with a heating plate under continuous magnetic agitation. When reaching the pre-set temperature, the fabric pieces were charged to the glass beaker and the temperature of the resulting mixture was maintained at 150° C. for 15 min. During this period, visible removal of colourants was affected by the aid of the ethyl lactate solvent, thereby rendering the fabric pieces slightly green and the solvent dark green. Then the slightly green fabric pieces were separated from the green solvent containing the removed colourants by standard solid-liquid filtration. After drying, one droplet of water was applied to the surface of one mainly decoloured piece of fabric. The droplet remained intact and did not spread over the surface (wetting) indicating the presence of the water-repellent coating on the surface of the fabric.

It is estimated that over 80% w/w of the amount of dye is removed from the fabric by the extraction process, despite the presence of the DWR coating. This shows that extraction of dyes from a polyester item with a solvent is possible, even when a DWR surface coating is present.

### Example 5

This examples shows the result of decolouring green fabric with ethyl lactate at lower temperatures. First, in total 1 g of the same green fabric with DWR-coating as used in Example 4, that is used in outdoor applications and is made of mainly PET fibers and 2% elastane fibers, was cut into small pieces. Then, 45 g of ethyl lactate was charged to a 150 mL glass beaker, which was equipped with thermometer, and the contents of the glass beaker was gently heated to 185° C. with a heating plate under continuous magnetic agitation. When reaching the pre-set temperature, the fabric pieces were charged to the glass beaker and the temperature of the resulting mixture was maintained at 85° C. for 15 min. During this period, only partial removal of colourants was affected by the aid of the ethyl lactate solvent rendering the solvent dark green, whereas the fabric pieces were still dark coloured. Then the fabric pieces were separated from the green solvent containing the removed colourants by standard solid-liquid filtration. After drying, one droplet of water was applied to the surface of one mainly decoloured piece of fabric. The droplet remained intact and did not spread over the surface (wetting) indicating the presence of the water-repellent coating on the surface of the fabric.

It is estimated that less than 50% w/w/ of the dye is extracted by the solvent.

### Example 6

Example 6 is another example of decolouring green fabric with diethylene glycol monoethyl ether, the fabric containing small amounts of elastane (PUR) yarns, mechanically connected to the polyester yarns. First, in total 2 g of the same green fabric with DWR-coating as used in Example 4, that is used in outdoor applications and is made of mainly PET fibers and 2% w/w elastane fibers, was cut into small pieces. Then, 80 g of diethylene glycol monoethyl ether (DGME) was charged to a 150 mL glass beaker, which was equipped with thermometer, and the contents of the glass beaker was gently heated to 180° C. with a heating plate under continuous magnetic agitation. When reaching the pre-set temperature, the fabric pieces were charged to the glass beaker and the temperature of the resulting mixture was maintained at 180° C. for 15 min. The fabric pieces showed almost complete colour removal and the solvent coloured red and appeared transparent already after 5 minutes.

Then the almost completely decoloured fabric pieces (slightly green) were separated from the red coloured solvent containing the removed colourants by standard solid-liquid filtration. Upon filtration, a white solid material started to form and to precipitate in the coloured solvent. This material was hypothesised to contain or be the polyurethane polymer of which the elastane yarns were made. After drying of the fabric pieces, one droplet of water was applied to the surface of one mainly decoloured piece of fabric. The droplet remained intact and did not spread over the surface (wetting) indicating the presence of the water-repellent coating on the surface of the fabric.

### Example 7

This example was performed to assess the use of the method with a textile waste comprising a relatively high amount of elastane. First, in total 10 g of a black fabric, that is used in outdoor applications and is made of PET fibers and mechanically connected thereto by weaving about 27% (w/w) elastane fibers, was cut into small pieces. Then, 50 g of diethylene glycol monoethyl ether (DGME) was charged to a 150 mL glass beaker, which was equipped with thermometer, and the contents of the glass beaker was gently heated to 180° C. with a heating plate under continuous magnetic agitation. When reaching the pre-set temperature, the fabric pieces were charged to the glass beaker and the temperature of the resulting mixture was maintained at 180° C. for 60 min. During this period, visible removal of colourants was affected by the aid of the DGME solvent, thereby rendering the fabric pieces grey and the solvent dark grey to black. It was furthermore noticed that the fabric structure of the pieces was changed as observed by the slightly wrinkled appearance of the pieces and sticking of pieces together. Then, the grey fabric pieces were separated from the grey to black solvent containing the removed colourants by standard solid-liquid filtration. Then, the grey to black coloured filtrate was poured into a 300 mL glass beaker containing 150 mL of demineralized water. Upon pouring immediately a dark grey suspension formed in which some solid material appeared to float in the course of several hours. The solid material was then separated from the dark grey suspension by standard solid-liquid filtration yielding a dark grey coloured residue, which was subsequently dried in vacuo. A good match with elastane references was found with standard analysis of the dried residue, which was obtained in 2.45 g yield indicating nearly complete removal and recovery of the polyurethane of the elastane present in the textile waste.

### Example 8

Example 8 shows the dissolution of compressed elastane fibers. First, elastane fibers were partly cut, hydraulically compressed (10 kN) on heated plates for 30 min, and subsequently the elastane plates were cut into small pieces. Then, 0.5 g of elastane pellets and 50 g of diethylene glycol monoethyl ether (DGME) were charged to a 100 mL glass beaker, which was equipped with thermometer, and the contents of the glass beaker was gently heated to 180° C. with a heating plate under continuous magnetic agitation. At the pre-set temperature, the elastane pellets were dissolved after a first stage of visible swelling at lower temperatures. After 10 min, an additional amount of 12 g of elastane pellets were added. The elastane pellets completely dissolved in the course of 10 min, thereby rendering the solution yellow and transparent. The solution turned slightly darker yellow in the following 60 min, after which it was cooled down to room temperature, thereby becoming slightly opaque.

### Example 9

Example 9 is a further example of dissolution of compressed elastane fibers. First, elastane fibers were processed into pellets like in Example 8. Then, 50 g of diethylene glycol monoethyl ether (DGME) was charged to a 150 mL glass beaker, which was equipped with thermometer, and the contents of the glass beaker was gently heated to 180° C. with a heating plate under continuous magnetic agitation. Then, 0.5 g of elastane pellets and 50 g of diethylene glycol monoethyl ether (DGME) were charged to a 100 mL glass beaker, which was equipped with thermometer, and the contents of the glass beaker was gently heated to 180° C. with a heating plate under continuous magnetic agitation. At the pre-set temperature, 2.5 g of elastane pellets were charged to the glass beaker and the temperature of the resulting mixture was maintained at 180° C. The elastane pellets readily dissolved after swelling first and the resulting solution appeared slightly yellow and transparent. Then, an additional portion of 2.5 g of elastane pellets was charged to the DGME solvent comprising the first dissolved portion of elastane pellets. Like the first portion of elastane pellets, the second portion of elastane pellets readily dissolved after swelling first and the resulting solution was slightly darker yellow. After dissolution of the second portion of elastane pellets, a third portion of 2.5 g elastane pellets was charged to the glass beaker comprising the first and second dissolved portions of elastane pellets. Like the first and second portions of elastane pellets, the third portion of elastane pellets readily dissolved after swelling first and the resulting solution was slightly darker yellow compared to the previous dissolved portions.

In total, 25 g of elastane pellets corresponding to 40% with respect to the DGME solvent, were charged to the DGME solvent and dissolved in the course of 2 to 2.5 hours, yielding a dark yellow to brown solution, which became slightly opaque after charging 15 g, or 30% with respect to the DGME solvent, of elastane pellets.

Then, the dark yellow to brown opaque solution comprising 20 g, or 40% with respect to the DGME solvent, of dissolved elastane pellets was poured into a 500 mL glass beaker containing 350 mL of demineralized water. Upon pouring immediately a yellow strand formed, which coagulated into a yellow coloured ball-shape article that sedimented at the bottom of the glass beaker in the course of several minutes. The yellow solid article was then separated from the slightly opaque demineralized water by standard solid-liquid filtration and dried in vacuo. Almost 20 g of elastane was recovered indicating nearly complete removal of the elastane.

### Example 10

In this example the dissolution of polyurethane foam as an item in textile waste was shown. First, a large piece of yellow flexible foam, that is used as interior in mattresses and is made of polyurethane, was cut into small parts. Then, 0.25 g of cut foam parts and 50 g of diethylene glycol monoethyl ether (DGME) were charged to a 100 mL glass beaker, which was equipped with thermometer, and the contents of the glass beaker was gently heated to 180° C. with a heating plate under continuous magnetic agitation. At the pre-set temperature, the cut foam parts slowly dissolved after a first stage of visible swelling at lower temperatures. After 10 min, the foam parts were completely dissolved yielding a brown and slightly opaque solution. The brown and slightly solution was kept at the pre-set temperature for 30 minutes after which it was cooled down to room temperature. After 72 hrs, the solution still appeared brown and opaque and showed no sedimentation, indicating the dissolved nature of the foam.

### Example 11

This example shows the decolouring blue fabric with xylene. First, in total 75 g of a blue coloured fabric that is used as sofa covering and made of PET fibers was cut into small pieces and subsequently charged to a 500 mL glass reactor, equipped with condenser, thermometer, and nitrogen inlet. Then, 450 g of xylene was added and the contents of the glass reactor was gently heated to reflux (140-145° C.) under continuous magnetic agitation. After reaching reflux conditions, the contents of the reactor was kept at this temperature for 60 min. During this period, visible removal of colourants was affected by the aid of the xylene solvent, which coloured dark blue and appeared transparent. Then the less coloured fabric pieces were separated from the solvent containing the removed colourants by standard solid-liquid filtration.

Then the fabric pieces of the first colourant removal step were charged to the 500 mL reactor, followed by 450 g of fresh xylene. The contents of the glass reactor was gently heated to reflux (140-145° C.) under continuous magnetic agitation. After reaching reflux conditions, the contents of the reactor was kept at this temperature for 60 min. During this period, visible removal of colourants was affected by the aid of the xylene solvent, thereby rendering the fabric pieces blueish and the solvent dark blue. The blueish fabric pieces were separated from the solvent containing the removed colourants by standard solid-liquid filtration.

Then the fabric pieces of the second colourant removal step were charged to the 500 mL reactor again, followed by 450 g of fresh xylene. The contents of the glass reactor was gently heated to reflux (140-145° C.) under continuous magnetic agitation. After reaching reflux conditions, the contents of the reactor was kept at this temperature for 60 min. During this period, visible removal of colourants was affected by the aid of the xylene solvent, thereby rendering the fabric pieces slightly blueish and the solvent blue. Then the slightly blueish fabric pieces were separated from the solvent containing the removed colourants by standard solid-liquid filtration.

Then the fabric pieces of the third colourant removal step were charged to the 500 mL reactor again, followed by 450 g of fresh xylene. The contents of the glass reactor was gently heated to reflux (140-145° C.) under continuous magnetic agitation. After reaching reflux conditions, the contents of the reactor was kept at this temperature for 60 min. During this period, the fabric pieces became almost white and the solvent still appeared blueish. The almost white fabric pieces were obtained by separating the solvent by standard solid-liquid filtration.

### Example 12

Example 12 briefly describes a few further comparative examples wherein DGME was used to try and dissolve polymer of another type than PUR or PET. Experiments were carried out using waste materials that next to dyes polyester contained either high density polyethylene (HDPE) or poly butylene terephthalate (PBT). It appeared that HDPE could not be dissolved in DGME, at least not to a significant amount. PBT also did not dissolve.

What is claimed is:

1. A process suitable for recycling textile waste including polyester yarns containing a dye, the process comprising the following consecutive steps:
a first step wherein the polyester yarns are treated with a solvent to extract a part of the dye from the polyester yarns,
a second step wherein the solvent treated polyester yarns are subjected to a method wherein the polyester is depolymerised into an oligomeric ester including in average between 3 and 30 monomeric units, wherein the remaining part of the dye is removed from the oligomeric ester by adsorption to a particulate matter that is in a mixture with the oligomeric ester, and
a third step wherein the oligomeric ester is separated from the particulate matter comprising the adsorbed dye, therewith providing a decolourised oligomeric ester suitable for repolymerisation, including in average between 3 and 30 monomeric units.

2. A process according to claim 1, wherein one of:
at least 50% of the dye is extracted from the polyester yarns in the first step,
at least 60% of the dye is extracted from the polyester yarns in the first step,
at least 70% of the dye is extracted from the polyester yarns in the first step,
at least 80% of the dye is extracted from the polyester yarns in the first step, or
at least 90% of the dye is extracted from the polyester yarns in the first step.

3. A process according to claim 1, wherein the particulate matter is chosen from the group consisting of activated carbon, zeolites, silica gel, activated alumina, inorganic minerals, chitosan, resin particles, carbon nanotubes and aluminophosphate molecular sieves.

4. A process according to claim 1, wherein the process comprises the step of filtering the oligomeric ester using a filter having a mesh size one of:
below 20 μm, or
between 5 and 10 μm.

5. A process according to claim 1, wherein the polyester is depolymerised into an oligomeric ester including in average between 5 and 20 monomeric units.

6. A process according to claim 1, wherein the solvent used to extract the dye from the polyester yarns is one of:
an ester or
an ether.

7. A process according to claim 6, wherein the solvent has a boiling temperature one of:
between 140 EC and 250 EC, or
between 150 EC and 220 EC.

8. A process according to claim 6, wherein the solvent is chosen from one of:
alkyl lactates,
glycol ethers,
ethyl lactate or
diethylene glycol monoethyl ether (DGME).

9. A process according to claim 1,
wherein the textile waste in addition to the polyester yarns comprises polyurethane (PUR) items, selected from the group consisting of PUR yarns, adhesive or foam, and
wherein, before the step of depolymerisation of the polyester, the PUR items are removed from the polyester yarns by at least one of:
mechanical methods and
chemical methods.

10. A process according to claim 9, wherein the PUR items are removed by using a PUR solvent.

11. A process according to claim 10, wherein the PUR solvent is the same solvent that extracts a part of the dye from the polyester yarns in the first process step.

12. A process according to claim 11, wherein the solvent is DGME.

13. A process according to claim 12, wherein the PUR polymer is obtained in purified form by pouring the DGME into water.

14. A process according to claim 1,
wherein the textile waste in addition to the polyester yarns comprises cotton items, including cotton yarns,
and
wherein, before the step of depolymerisation of the polyester, the cotton items are removed from the polyester yarns by at least one of:
mechanical methods and
chemical methods.

15. A process according to claim 1, wherein the polyester is depolymerised into an oligomeric ester by alcoholysis.

16. A process according to claim 15, wherein the polyester is depolymerised into an oligomeric ester by a two-step procedure, comprising two separate consecutive steps, in both of which alcohol is added to depolymerise the polyester.

17. A process according to claim 16, wherein in the first of the two consecutive steps the polyester is fed to an extruder operated at a temperature above the melting temperature of the polyester, while a first amount of alcohol is co-fed to the extruder, in order to produce a fluid mixture comprising a melt of at least partly depolymerised polyester, and in the second of the two consecutive steps the said fluid mixture is fed to a continuously stirred tank reactor (CSTR) operated at a temperature above the melting temperature of the polyester, while co-feeding a second amount of alcohol to the CSTR to provide the oligomeric ester.

18. A process according to claim 1
wherein the polyester is polyethylene terephthalate (PET), and wherein the oligomeric ester for one of:
over 50% w/w,
over 60% w/w,
over 70% w/w,
over 80% w/w, or
over 90% w/w, comprises oligomers of one of:
4 to 16 Bis(2-Hydroxyethyl) terephthalate (BHET) units,
6 to 14 (BHET) units, or
8 to 10 BHET units.

19. A process according to claim 1, wherein after extraction of the dye with the solvent, the dye is removed from the solvent in a separate step to provide purified dye and purified solvent.

20. A process according to claim 1, wherein after the oligomeric ester is separated from the particulate matter comprising the adsorbed dye, the dye is removed from the particulate matter to provide purified dye and purified particulate matter.

21. A process according to claim 1, wherein the process is preceded by one or more of the steps chosen from the group of:
1) removing any trims including buttons, zippers and labels from the textile waste,
2) washing the textile waste and
3) shredding the textile waste into smaller pieces.
